(19) United States
(12) Patent Application Publication
(10) Pub. No.: US 2026/0356336 A1
(43) Pub. Date: Nov. 12, 2026

(54) PRESSURE ACCUMULATORS IN BRAKING SYSTEMS

(71) Applicant: Ford Global Technologies, LLC, Dearborn, MI (US)

(72) Inventors: Stuart Craig Salter, White Lake, MI (US); Michael John Kipley, Saline, MI (US); Kenneth Patrick McHugh, Canton, MI (US); William Lee Steinhour III, Newport, MI (US); Vincent Patrick Isopi, Livonia, MI (US); Scott Lawrence Mlynarczyk, South Lyon, MI (US)

(21) Appl. No.: 19/090,098

(22) Filed: Mar. 25, 2025

(51) Int. Cl. B60T 13/14

(52) U.S. Cl. CPC B60T 13/148; B60T 13/141

(57) ABSTRACT

A disclosed example brake system includes: a hydraulic fluid chamber having a first output port and a second output port; an automatic emergency braking (AEB) pressure accumulator having an input port and an output port; an isolation valve coupled to the first output port of the hydraulic fluid chamber; an accumulator valve coupled to the second output port of the hydraulic fluid chamber and the input port of the AEB pressure accumulator; and a pressure activation valve coupled to the output port of the AEB pressure accumulator.

### FIELD OF THE DISCLOSURE

This disclosure relates generally to vehicle braking systems and, more particularly, to pressure accumulators in braking systems.

### BACKGROUND

Vehicles include multiple subsystems to carry out various functions. A braking subsystem enables a driver to decrease vehicle speed by controlling an amount of braking resistance applied to wheels of the vehicle. For example, a brake pedal may be controlled by the driver to cause a braking force to be applied to the wheels.

### SUMMARY

An example brake system includes a hydraulic fluid chamber having a first output port and a second output port, an automatic emergency braking (AEB) pressure accumulator having an input port and an output port, an isolation valve coupled to the first output port of the hydraulic fluid chamber, an accumulator valve coupled to the second output port of the hydraulic fluid chamber and the input port of the AEB pressure accumulator, and a pressure activation valve coupled to the output port of the AEB pressure accumulator.

An example brake system includes an automatic emergency braking (AEB) pressure accumulator, an accumulator valve coupled to an input port of the AEB pressure accumulator, and a pressure activation valve coupled to an output port of the AEB pressure accumulator, wherein during an AEB pre-charge phase, the accumulator valve is open and the pressure activation valve is closed, and during an AEB event, the accumulator valve is closed and the pressure activation valve is open.

An example vehicle includes a wheel brake, an automatic emergency braking (AEB) pressure accumulator, an isolation valve coupled to the wheel brake via a hydraulic fluid brake line, an accumulator valve coupled to the AEB pressure accumulator, and a pressure activation valve coupled to the AEB pressure accumulator, the pressure activation valve coupled to the wheel brake via the hydraulic fluid brake line.

### BRIEF DESCRIPTION OF THE DRAWINGS

FIG. 1 is a perspective view of a vehicle that includes an example brake controller and an example AEB pressure accumulator as part of a vehicle brake system.

FIG. 2 is an example vehicle brake system of the vehicle of FIG. 1 that includes the brake controller of FIG. 1 to control wheel brakes of the vehicle.

FIG. 3 is a portion of the vehicle brake system of FIG. 2 that includes the example AEB pressure accumulator and a plurality of valves.

In general, the same reference numbers will be used throughout the drawings and accompanying written description to refer to the same or like parts. The figures are not necessarily to scale.

### DETAILED DESCRIPTION

Examples disclosed herein relate to automatic emergency braking (AEB) in vehicles. AEB systems contribute to bringing a vehicle to a full stop within a specified distance relative to when a situation requiring a full stop is detected. A number of factors may contribute to a vehicle's ability to stop within the specified distance. For example, friction coefficients of tires can vary significantly across different types of tires. Road tires have a higher coefficient of friction on road surfaces than off-road tires. Examples disclosed herein can be used to increase the AEB application speed to decrease full stop braking distances of vehicles across different tire types and/or across other vehicle characteristics affecting braking performance.

In examples disclosed herein, a hydraulic pressure accumulator is provided to allow for faster build-up of desired brake torque by substantially reducing or eliminating elastic deformability (e.g., compliance) of a brake system. Elastic deformability or compliance occurs in a brake system when there is insufficient hydraulic fluid pressure in hydraulic fluid brake lines to firmly actuate wheel brakes. Examples disclosed herein can be used to quickly supply such hydraulic fluid pressure in the brake lines in response to detected AEB events. This results in quicker initial deceleration of a vehicle before a full amount of AEB pressure reaches the vehicle's wheels.

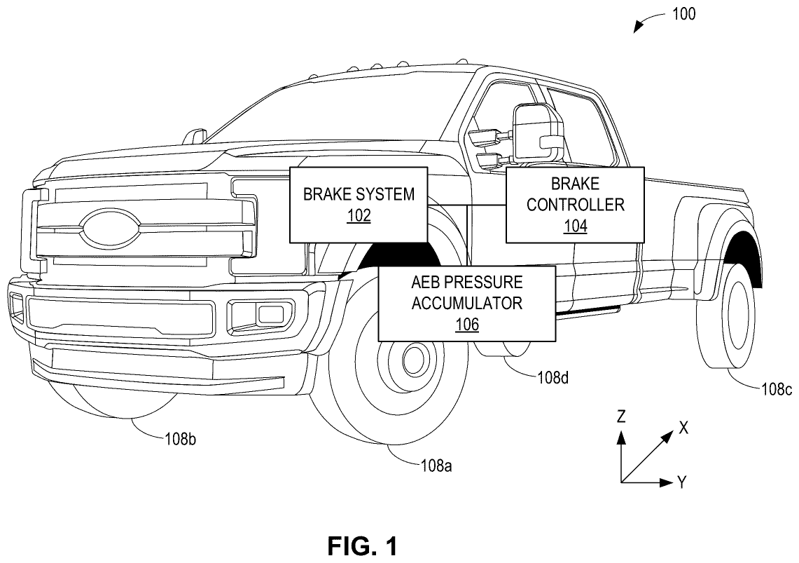

FIG. 1 is a perspective view of a vehicle 100 in which examples disclosed herein can be implemented. In the illustrated example of FIG. 1, the vehicle 100 includes an example vehicle brake system 102, an example brake controller 104, an example AEB pressure accumulator 106, an example first wheel 108a, an example second wheel 108b, an example third wheel 108c, and an example fourth wheel 108d.

The vehicle 100 is a motorized wheel-driven vehicle. In the illustrated example of FIG. 1, the vehicle 100 is a pick-up truck. In other examples, the vehicle 100 can be any type of vehicle with brakes (e.g., a sedan, a coupe, a van, a pick-up truck, a sports utility vehicle, an all-terrain vehicle (ATV), farming equipment, etc.). The vehicle 100 may be a fully electric vehicle, a hybrid vehicle including an internal combustion engine and electrical drive components, or an internal combustion engine (e.g., a non-electrified vehicle, a partially electrified vehicle, etc.).

In the illustrated example of FIG. 1, the vehicle brake system 102 is implemented as a hydraulic brake system. The vehicle brake system 102 includes components that slow the rotation of the wheels 108a, 108b, 108c, 108d. The vehicle brake system 102 can receive user input (e.g., via a brake pedal, a parking brake lever/switch/pedal, etc.) or machine input (e.g., an AEB command, a command from an advanced driver-assistance system (ADAS), etc.) and cause activation of one or more brake(s) of the vehicle brake system 102.

The wheels 108a, 108b, 108c, 108d include wheel rims and corresponding tires. While in the illustrated example of FIG. 1, the vehicle 100 has two axles and four wheels, in other examples, the vehicle 100 can have any number of axles and wheels. In the illustrated example of FIG. 1, the first wheel 108a and the second wheel 108b are front wheels and the third wheel 108c and the fourth wheel 108d are rear wheels. In the illustrated example of FIG. 1, the first wheel 108a and the third wheel 108c are driver-side wheels and the second wheel 108b and the fourth wheel 108d are passenger-side wheels.

During operation of the vehicle 100, the vehicle brake system 102 is controlled via user input and the brake controller 104. For example, in response to a user input (e.g., the depression of a brake pedal, etc.) and/or a machine input (e.g., a command from an ADAS, etc.), the vehicle brake system 102 applies braking force(s) on one or more of the wheels 108a-d to slow the rotation of some or all of the wheels 108a-d, thereby slowing the vehicle 100. Additionally, upon detection of an emergency braking scenario (e.g., an AEB command due to a detected obstacle and/or for any other pertinent reason), the brake controller 104 causes the vehicle brake system 102 to apply braking force(s) on one or more of the wheels 108a-d to bring the vehicle 100 to a full stop. The AEB pressure accumulator 106 stores hydraulic fluid pressure that can be used to apply the braking force(s) on the wheels 108a-d during an emergency braking scenario.

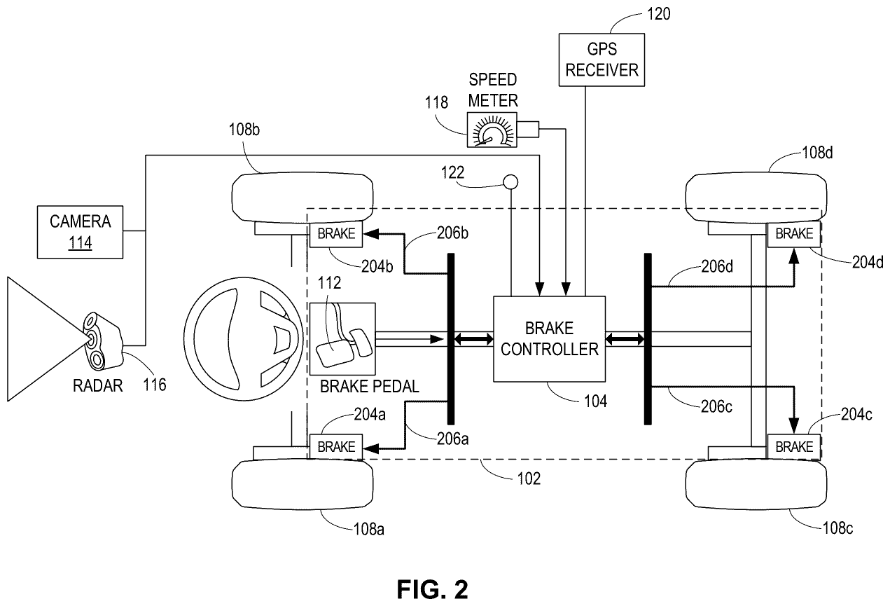

FIG. 2 is the example vehicle brake system 102 of the vehicle 100 of FIG. 1 that includes example wheel brakes 204a-d at corresponding ones of the wheels 108a-d of the vehicle 100. In the example of FIG. 2, the vehicle braking system 102 also includes the brake controller 104 to control the wheel brakes 204a-d. The brake controller 104 includes an automatic emergency braking (AEB) controller and an electronic brake booster (EBB) controller. The brake controller 104 may be instantiated (e.g., creating an instance of, bring into being for any length of time, materialize, implement, etc.) by programmable circuitry. For example, programmable circuitry may be implemented by a Central Processor Unit (CPU) executing first instructions, a Field Programmable Gate Array (FPGA), a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the brake controller 104 may be instantiated (e.g., creating an instance of, bring into being for any length of time, materialize, implement, etc.) by (i) an Application Specific Integrated Circuit (ASIC) and/or (ii) a FPGA (e.g., another form of programmable circuitry) structured and/or configured in response to execution of second instructions to perform operations corresponding to the first instructions.

The brake controller 104 controls the wheel brakes 204a-d via corresponding example hydraulic fluid brake lines 206a-d by causing hydraulic fluid pressure to be increased and decreased in the hydraulic fluid brake lines 206a-d. Increasing hydraulic fluid pressure in the hydraulic fluid brake lines 206a-d drives brake pistons of the wheel brakes 204a-d. The brake pistons drive brake pads or brake shoes against corresponding disc rotors or drums to slow the wheels 108a-d. The vehicle 100 is provided with an example brake pedal 112 to receive driver input that causes the brake controller 104 to actuate or release the wheel brakes 204a-d.

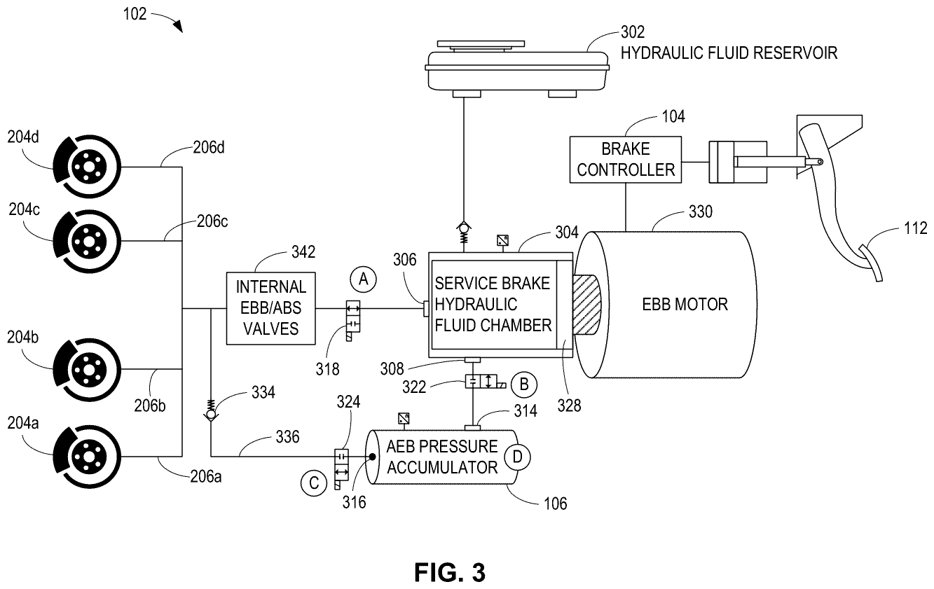

The brake controller 104 implements AEB to assist a driver in braking the vehicle 100 during AEB events. For example, when the brake controller 104 detects an AEB event, the brake controller 104 causes a pressure increase in the hydraulic fluid brake lines 206a-d without waiting for user input (e.g., depressing the brake pedal 112). Creating such pressure increase independent of user input causes a relatively quick actuation of the wheel brakes 204a-d so that the duration of slowing the vehicle 100 can be decreased relative to relying solely on driver input to operate the wheel brakes 204a-d. As used herein, a brake actuation time is a duration between a first time at which the brake controller 104 detects an AEB event and a second time at which the wheel brakes 204a-d are actuated to begin slowing the vehicle 100. To decrease a brake actuation time, the brake controller 104 controls pre-charging of the AEB pressure accumulator 106 so that the AEB pressure accumulator 106 stores accumulated hydraulic fluid pressure that can subsequently be used to actuate the wheel brakes 204a-d in response to a detected AEB event. Pre-charging of the AEB pressure accumulator 106 is described in more detail below in connection with FIG. 3.

In examples disclosed herein, the pre-charging of the AEB pressure accumulator 106 with hydraulic fluid pressure is performed during an AEB pre-charge phase, and use of the hydraulic fluid pressure accumulated in the AEB pressure accumulator 106 occurs in an AEB activation phase during an AEB event. In some examples, the pre-charging of the AEB pressure accumulator 106 is performed in response to starting of the vehicle 100. In some examples, starting of the vehicle is referred to as a “key on” event or an “ignition on” event regardless of whether the starting of the vehicle is based on a physical key actuated in a keyed ignition switch, or based on a wireless key fob for keyless ignition, or based on remotely starting the vehicle (e.g., using a remote control, an app-based start command from a smart phone, tablet, etc., or any other remote starting technique).

In other examples, the pre-charging of the AEB pressure accumulator 106 can be based on one or more factors indicative of when AEB might be applied. For example, the brake controller 104 may control pre-charging of the AEB pressure accumulator 106 based on specific situations. The brake controller 104 may interpret one or a combination of factors as representing when AEB may be used. In some examples, a combination of factors can be analyzed as a weighted average of those factors, based on Boolean logic, or any other suitable factor-analysis technique. Example factors include front camera and/or radar recognition of potential brake-inducing features, speed, yellow light intersection scenarios, road features, geographic location, time of day, obstacle detection, and noise. To create such data for the brake controller 104, the vehicle 100 is provided with an example camera 114, an example radar 116, an example speed meter 118, an example global positioning system (GPS) receiver 120, and an example microphone 122.

Image recognition via the camera 114 and/or radar recognition via the radar 116 of potential brake-inducing features includes recognizing objects such as parallel parked vehicles, construction-site obstructions, parking lot obstacles, bus stops, etc. The speed meter 118 is provided to measure a speed of the vehicle 100. A speed factor based on such speed measurement values from the speed meter 118 may be used to consider slower vehicle speeds (e.g., 12~30 miles per hour) as indicative of possible use of AEB. For example, the vehicle 100 traveling at a slower speed may indicate that it is traveling through a congested area or through an area having a higher likelihood of sudden encounters with obstacles in the road.

Image recognition using the camera 114 can produce a yellow light intersection factor based on the vehicle 100 approaching a traffic-light controlled intersection in which the traffic light has turned yellow when the vehicle 100 is within a threshold distance to the intersection. A road features factor represents particular road features (e.g., traffic circles) that increase the likelihood of AEB use. A geographic location factor represents sections of road with high accident occurrences. The road features factor and the geographic location factor may be generated based on information from the GPS receiver 120 in combination with road map data and/or historical traffic incident data.

A time of day factor may be generated by a clock of the vehicle 100 and represents times during a day (e.g., rush hour) and/or days of a week (e.g., workdays) that increase the likelihood of AEB use. The obstacle detection factor represents when pedestrians are present (e.g., an obstacle in the road or a moving obstacle at a side of a road that could move into the road) and may be generated based on the camera 114 and/or the radar 116. A noise factor may be generated using the microphone 122 to detect noises that represent road conditions (e.g., a bumpy road, a road surface type, etc.) or environmental conditions (e.g., temperature, rain, snow, etc.) that increase the likelihood of AEB use.

In some examples, the brake controller 104 may obtain at least some of the above information from a cloud service via a wireless communication interface of the vehicle 100. In some examples, the vehicle 100 can log AEB events and report AEB event logs to the cloud service. The AEB event logs may be used by the cloud service to track geographic locations (e.g., on-road locations, off-road locations, parking lots, etc.) of frequent AEB use. The cloud service may tag particular geographic locations as pre-charge locations when they are associated with a threshold number of AEB events. The vehicle 100 can then receive pre-charge location tags from the cloud service in substantially real time as the vehicle 100 approaches a corresponding geographic location. The brake controller 104 can use the pre-charge location tags to determine when to pre-charge the AEB pressure accumulator 106.

FIG. 3 is a portion of the vehicle brake system 102 of FIG. 2 that includes the brake controller 104 and the AEB pressure accumulator 106. The brake controller 104 is coupled to the brake pedal 112 to receive driver inputs via presses of the brake pedal 112. The vehicle brake system 102 includes an example hydraulic fluid reservoir 302 and an example service brake hydraulic fluid chamber 304. The hydraulic fluid reservoir 302 stores hydraulic fluid and is coupled to the hydraulic fluid chamber 304 to provide the hydraulic fluid to the hydraulic fluid chamber 304. The hydraulic fluid chamber 304 includes an example first output port 306 and an example second output port 308. The vehicle brake system 102 also includes the AEB pressure accumulator 106 which includes an example input port 314 and an example output port 316.

The vehicle brake system 102 includes a plurality of example valves 318, 322, 324. For example, the vehicle brake system 102 includes an example service brake hydraulic isolation valve 318, an example AEB hydraulic accumulator valve 322, and an example AEB hydraulic pressure activation valve 324. The isolation valve 318 is coupled to the first output port 306 of the hydraulic fluid chamber 304. The accumulator valve 322 is coupled to the second output port 308 of the hydraulic fluid chamber 304 and to the input port 314 of the AEB pressure accumulator 106. The pressure activation valve 324 is coupled to the output port 316 of the AEB pressure accumulator 106. In the example of FIG. 3, the isolation valve 318 is between the hydraulic fluid chamber 304 and the wheel brakes 204a-d and is coupled to the wheel brakes 204a-d via the hydraulic fluid brake lines 206a-d. Also in the example of FIG. 3, the pressure activation valve 324 is between the AEB pressure accumulator 106 and the wheel brakes 204a-d and is coupled to the wheel brakes 204a-d via the hydraulic fluid brake lines 206a-d.

During a non-AEB braking event, the isolation valve 318 is open, the accumulator valve 322 is closed, and the pressure activation valve 324 is closed. For example, the isolation valve 318 is normally open to allow the wheel brakes 204a-d to operate based on driver input (e.g., a driver pressing the brake pedal 112), the accumulator valve 322 is normally closed to isolate the AEB pressure accumulator 106 from affecting operation of the wheel brakes 204a-d based on driver input, and the pressure activation valve 324 is normally closed. During these opened/closed configurations of the valves 318, 322, 324, the AEB pressure accumulator 106 stores hydraulic pressure for use when an AEB event occurs while allowing the wheel brakes 204a-d to be operated based on driver input.

The vehicle brake system 102 includes an example piston 328 in the hydraulic fluid chamber 304 and an example EBB motor 330 coupled to the piston 328. An EBB controller in the brake controller 104 controls the EBB motor 330 to actuate (e.g., extend or retract) the piston 328 in the hydraulic fluid chamber 304 to change (e.g., increase or decrease) hydraulic fluid pressure in the hydraulic fluid brake lines 206a-d. For example, in response to a driver input brake signal (e.g., a driver pressing the brake pedal 112) received during a non-AEB braking event, the brake controller 104 activates the EBB motor 330 to drive the piston 328 into (e.g., extend the piston into) the hydraulic fluid chamber 304. Accordingly, the piston 328 pushes hydraulic fluid through the first output port 306 of the hydraulic fluid chamber 304 to the isolation valve 318 without pushing the hydraulic fluid through the second output port 308 of the hydraulic fluid chamber 304 to the accumulator valve 322. Pushing hydraulic fluid through the first output port 306 of the hydraulic fluid chamber 304 to the isolation valve 318 delivers the hydraulic fluid to (e.g., increases hydraulic fluid pressure at) the wheel brakes 204a-d through the hydraulic fluid brake lines 206a-d, which activates the wheel brakes 204a-d to slow the vehicle 100. The brake controller 104 changes the closed/opened states of the valves 318, 322, 324 during an AEB pre-charge phase in which hydraulic fluid pressure is accumulated in the AEB pressure accumulator 106 and during an AEB activation phase in which the pressure in the AEB pressure accumulator 106 is used to operate the wheel brakes 204a-d during an AEB event.

During an AEB pre-charge phase, the isolation valve 318 is closed, the accumulator valve 322 is open, the pressure activation valve 324 is closed, and the EBB motor 330 drives the piston 328 to push hydraulic fluid through the second output port 308 of the hydraulic fluid chamber 304 and through the accumulator valve 322 to the AEB pressure accumulator 106. For example, during the AEB pre-charge phase, the brake controller 104 energizes (e.g., supplies an electrical current and/or voltage to) the isolation valve 318 to close the isolation valve 318 and energizes the accumulator valve 322 to open the accumulator valve 322. Closing the isolation valve 318 prevents hydraulic fluid that is pushed out of the hydraulic fluid chamber 304 by the EBB motor 330 from reaching and actuating the wheel brakes 204a-d. Opening the accumulator valve 322 allows the hydraulic fluid that is pushed out of the hydraulic fluid chamber 304 by the EBB motor 330 to reach and accumulate in the AEB pressure accumulator 106. Accumulating the hydraulic fluid in the AEB pressure accumulator 106 increases a hydraulic fluid pressure in the AEB pressure accumulator 106 so that the AEB pressure accumulator 106 becomes pre-charged for later use during an AEB event.

As the hydraulic fluid is accumulated in the AEB pressure accumulator 106 during the AEB pre-charge phase, the brake controller 104 compares the accumulated pressure in the AEB pressure accumulator 106 to a pressure threshold value. The pressure threshold value can be selected based on a number of factors such as how quickly the wheel brakes 204a-d are to be actuated by the AEB pressure accumulator 106 in response to a detected AEB event, a pressure rating of the AEB pressure accumulator 106, pressure ratings of the accumulator valve 322 and the pressure actuation valve 324, etc. When the brake controller 104 determines that the amount of accumulated pressure in the AEB pressure accumulator 106 has increased to a level that satisfies the pressure threshold value, the brake controller 104 de-energizes the accumulator valve 322 to close the accumulator valve 322. Closing the accumulator valve 322 maintains the accumulated pressure in the AEB pressure accumulator 106 by preventing hydraulic fluid from being released from the AEB pressure accumulator 106. In addition, the brake controller 104 activates the EBB motor 330 to retract the piston 328 to normalize the pressure level in the service brake hydraulic fluid chamber 304 and de-energizes the isolation valve 318 to allow the wheel brakes 204a-d to be operated based on driver input (e.g., a driver pressing the brake pedal 112) during non-AEB braking events.

When the brake controller 104 detects an AEB event, the brake controller 104 controls the opened/closed states of the valves 318, 322, 324 to allow the hydraulic pressure accumulated in the AEB pressure accumulator 106 to be supplied through the pressure activation valve 324 to the wheel brakes 204a-d via the hydraulic fluid brake lines 206a-d. For example, in response to detection of an AEB event, the brake controller 104 enters the AEB activation phase in which the isolation valve 318 remains open, the accumulator valve 322 remains closed, and the brake controller 104 energizes (e.g., supplies electrical current and/or voltage to) the pressure activation valve 324 to open the pressure activation valve 324. By opening the pressure activation valve 324, hydraulic fluid accumulated in the AEB pressure accumulator 106 is allowed to flow to the wheel brakes 204a-d via the hydraulic fluid brake lines 206a-d. In the illustrated example, an example check valve 334 is coupled between the pressure activation valve 324 and the wheel brakes 204a-d. For example, the check valve 334 is provided in an example hydraulic fluid line 336 that connects the AEB pressure accumulator 106 with the hydraulic fluid brake lines 206a-d. The check valve 334 prevents hydraulic fluid pressure to back propagate through the pressure activation valve 324 and into the AEB pressure accumulator 106 from the isolation valve 318.

Opening the pressure activation valve 324 eliminates compliance (e.g., elastic deformability) in the brake pistons of the wheel brakes 204a-d (e.g., due to low pressure in the hydraulic fluid brake lines 206a-d) and allows the hydraulic fluid pressure from the AEB pressure accumulator 106 to drive brake pads or brake shoes of the wheel brakes 204a-d against corresponding braking surfaces (e.g., disc rotor surfaces or drum surfaces) to create brake torque and an initial deceleration of the vehicle 100. In some examples, the deceleration amount can be tuned to the dynamics of the vehicle 100 to provide a maximum normal force (e.g., a force normal to braking surfaces) to achieve an effective braking-based deceleration. By using the hydraulic pressure accumulated in the AEB pressure accumulator 106, the pressure actuates the wheel brakes 204a-d to slow the vehicle 100 faster than possible by operating the wheel brakes 204a-d based on driver input via the brake pedal 112 alone.

After the hydraulic fluid pressure in the AEB pressure accumulator 106 is depleted, the brake controller 104 de-energizes the pressure activation valve 324 to close it and activates the EBB motor 330 to drive the piston 328 and send additional AEB hydraulic pressure based on hydraulic fluid in the hydraulic fluid chamber 304. By continuing to supply positive hydraulic pressure based on the EBB motor 330, the brake controller 104 can continue the in-progress AEB braking to further operate the wheel brakes 204a-d. By using the AEB pressure accumulator 106 in combination with the EBB motor 330 during an AEB event, examples disclosed herein implement a stepped AEB-based slowing of the vehicle 100. For example, a first step involves delivering an initial faster-response pressure from the AEB pressure accumulator 106 to the wheel brakes 204a-d to create an initial fast AEB response, and a second step involves delivering subsequent pressure from the hydraulic fluid chamber 304 based on the EBB motor 330 for continued AEB braking. Accordingly, use of the AEB pressure accumulator 106 during an AEB event provides a reduced response time for AEB activation and is a precursor to continued AEB braking based on the hydraulic fluid chamber 304 and the EBB motor 330.

As shown in the example of FIG. 3, the vehicle brake system 102 includes example internal EBB/ABS (anti-lock braking system) valves 342 that are connected to the hydraulic fluid brake lines 206a-d and located between the isolation valve 318 and the wheel brakes 204a-d. The isolation valve 318 is connected to the EBB/ABS valves 342 so that hydraulic fluid that flows through the isolation valve 318 also flows through the EBB/ABS valves 342. Any suitable configuration of the internal EBB/ABS valves 342 may be implemented in the vehicle brake system 102 to control EBB and ABS features of the vehicle 100.

Although one AEB pressure accumulator 106, one hydraulic fluid chamber 304, one EBB motor 330, and one of each of the valves 318, 322, 324 are provided in the example vehicle brake system 102, in other examples, multiples ones of any one or more of the AEB pressure accumulator 106, the hydraulic fluid chamber 304, the EBB motor 330, and/or the valves 318, 322, 324 may be provided. For example, a set of these components may be provided for front wheel brakes 204a, b and another set of these components may be provided for the rear wheel brakes 204c, d.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” modifies its subjects/values to recognize the potential presence of variations that occur in real-world applications. For example, “approximately” may modify times, distances, and/or dimensions that may not be exact due to environmental conditions, manufacturing variances, manufacturing tolerances and/or other real-world imperfections as will be understood by persons of ordinary skill in the art. For example, “approximately” may indicate such times, distances, and/or dimensions may be within a tolerance range of +/−10% unless otherwise specified herein.

As used herein “substantially real time” refers to occurrence in a near instantaneous manner recognizing there may be real-world delays for computing time, transmission, etc. Thus, unless otherwise specified, “substantially real time” refers to real time+1 second.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein, integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed to implement pressure accumulators in braking systems. Disclosed systems, apparatus, articles of manufacture, and methods enhance AEB in vehicles by providing valves that facilitate pre-charging AEB pressure accumulators so that accumulated and stored hydraulic fluid pressure can be subsequently used to actuate wheel brakes relatively quicker than solely relying on driver input (e.g., pressing a brake pedal) to activate the wheel brakes. Disclosed systems, apparatus, articles of manufacture, and methods are accordingly directed to enhancing AEB in vehicles.

Example methods, apparatus, systems, and articles of manufacture to implement pressure accumulators in braking systems are disclosed herein. Further examples and combinations thereof include the following:

Example 1 includes a brake system comprising a hydraulic fluid chamber having a first output port and a second output port, an automatic emergency braking (AEB) pressure accumulator having an input port and an output port, an isolation valve coupled to the first output port of the hydraulic fluid chamber, an accumulator valve coupled to the second output port of the hydraulic fluid chamber and the input port of the AEB pressure accumulator, and a pressure activation valve coupled to the output port of the AEB pressure accumulator.

Example 2 includes the brake system of example 1, further including a piston in the hydraulic fluid chamber, and a motor coupled to the piston, the motor to actuate the piston in the hydraulic fluid chamber, wherein, during an AEB pre-charge phase the isolation valve is closed, the accumulator valve is open, and the pressure activation valve is closed, and the motor drives the piston to push hydraulic fluid through the second output port of the hydraulic fluid chamber through the accumulator valve to the AEB pressure accumulator.

Example 3 includes the brake system of one or both of example 1 and/or example 2, wherein the accumulator valve is to close after an increase in hydraulic pressure in the AEB pressure accumulator based on the hydraulic fluid, the hydraulic pressure to be used during an AEB event.

Example 4 includes the brake system of any one or more of examples 1-3, wherein during a non-AEB braking event, the isolation valve is open, the accumulator valve is closed, and the pressure activation valve is closed, and during an AEB event, the isolation valve is open, the accumulator valve is closed, and the pressure activation valve is open.

Example 5 includes the brake system of any one or more of examples 1-4, further including a piston in the hydraulic fluid chamber, and a motor coupled to the piston, the motor to actuate the piston in the hydraulic fluid chamber, wherein during the non-AEB braking event, the piston is to push hydraulic fluid through the first output port of the hydraulic fluid chamber to the isolation valve without pushing the hydraulic fluid through the second output port of the hydraulic fluid chamber to the accumulator valve, and during the AEB event, the hydraulic fluid is to flow from the AEB pressure accumulator to a wheel brake through the pressure activation valve.

Example 6 includes the brake system of any one or more of examples 1-5, further including a check valve coupled between the pressure activation valve and a wheel brake.

Example 7 includes the brake system of any one or more of examples 1-6, wherein the isolation valve is connected to an anti-lock braking system valve.

Example 8 includes a brake system comprising an automatic emergency braking (AEB) pressure accumulator, an accumulator valve coupled to an input port of the AEB pressure accumulator, and a pressure activation valve coupled to an output port of the AEB pressure accumulator, wherein during an AEB pre-charge phase, the accumulator valve is open and the pressure activation valve is closed, and during an AEB event, the accumulator valve is closed and the pressure activation valve is open.

Example 9 includes the brake system of example 8, further including a hydraulic fluid chamber, and an isolation valve between the hydraulic fluid chamber and wheel brakes, wherein, during the AEB pre-charge phase, the isolation valve is closed.

Example 10 includes the brake system of one or both of example 8 and/or example 9, wherein, during the AEB pre-charge phase, the accumulator valve is to close after an increase in hydraulic pressure in the AEB pressure accumulator, the hydraulic pressure to be used during the AEB event.

Example 11 includes the brake system of any one or more of examples 8-10, wherein, during a non-AEB braking event, the accumulator valve is closed, and the pressure activation valve is closed.

Example 12 includes the brake system of any one or more of examples 8-11, further including a hydraulic fluid chamber, an isolation valve coupled to the hydraulic fluid chamber, and a piston, wherein during the non-AEB braking event, the piston is to push hydraulic fluid from the hydraulic fluid chamber to the isolation valve without pushing the hydraulic fluid to the accumulator valve, and during the AEB event, the hydraulic fluid is to flow from the AEB pressure accumulator to a wheel brake through the pressure activation valve.

Example 13 includes the brake system of any one or more of examples 8-13, further including a check valve coupled between the pressure activation valve and a wheel brake.

Example 14 includes a vehicle comprising a wheel brake, an automatic emergency braking (AEB) pressure accumulator, an isolation valve coupled to the wheel brake via a hydraulic fluid brake line, an accumulator valve coupled to the AEB pressure accumulator, and a pressure activation valve coupled to the AEB pressure accumulator, the pressure activation valve coupled to the wheel brake via the hydraulic fluid brake line.

Example 15 includes the vehicle of example 14, further including a hydraulic fluid chamber, the isolation valve located between the hydraulic fluid chamber and the wheel brake, a piston in the hydraulic fluid chamber, and a motor coupled to the piston, wherein, during an AEB pre-charge phase the isolation valve is closed, the accumulator valve is open, and the pressure activation valve is closed, and the motor drives the piston to push hydraulic fluid from the hydraulic fluid chamber through the accumulator valve to the AEB pressure accumulator.

Example 16 includes the vehicle of one or both of example 14 and/or example 15, wherein the accumulator valve is to close after an increase in hydraulic pressure in the AEB pressure accumulator based on the hydraulic fluid, the hydraulic pressure to be used during an AEB event.

Example 17 includes the vehicle of any one or more of examples 14-16, wherein during a non-AEB braking event, the isolation valve is open, the accumulator valve is closed, and the pressure activation valve is closed, and during an AEB event, the isolation valve is open, the accumulator valve is closed, and the pressure activation valve is open.

Example 18 includes the vehicle of any one or more of examples 14-17, further including a hydraulic fluid chamber, and a piston in the hydraulic fluid chamber, wherein during the non-AEB braking event, the piston is to push hydraulic fluid from the hydraulic fluid chamber to the isolation valve without pushing the hydraulic fluid to the accumulator valve, and during the AEB event, the hydraulic fluid is to flow from the AEB pressure accumulator to the wheel brake through the pressure activation valve.

Example 19 includes the vehicle of any one or more of examples 14-18, further including a check valve coupled between the pressure activation valve and the wheel brake.

Example 20 includes the vehicle of any one or more of examples 14-19, wherein the isolation valve is connected to an anti-lock braking system valve.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A brake system comprising:
a hydraulic fluid chamber having a first output port and a second output port;
an automatic emergency braking (AEB) pressure accumulator having an input port and an output port;
an isolation valve coupled to the first output port of the hydraulic fluid chamber;
an accumulator valve coupled to the second output port of the hydraulic fluid chamber and the input port of the AEB pressure accumulator; and
a pressure activation valve coupled to the output port of the AEB pressure accumulator.

2. The brake system of claim 1, further including:
a piston in the hydraulic fluid chamber; and
a motor coupled to the piston, the motor to actuate the piston in the hydraulic fluid chamber, wherein, during an AEB pre-charge phase:
the isolation valve is closed, the accumulator valve is open, and the pressure activation valve is closed; and
the motor drives the piston to push hydraulic fluid through the second output port of the hydraulic fluid chamber through the accumulator valve to the AEB pressure accumulator.

3. The brake system of claim 2, wherein the accumulator valve is to close after an increase in hydraulic pressure in the AEB pressure accumulator based on the hydraulic fluid, the hydraulic pressure to be used during an AEB event.

4. The brake system of claim 1, wherein:
during a non-AEB braking event, the isolation valve is open, the accumulator valve is closed, and the pressure activation valve is closed; and
during an AEB event, the isolation valve is open, the accumulator valve is closed, and the pressure activation valve is open.

5. The brake system of claim 4, further including:
a piston in the hydraulic fluid chamber; and
a motor coupled to the piston, the motor to actuate the piston in the hydraulic fluid chamber, wherein:
during the non-AEB braking event, the piston is to push hydraulic fluid through the first output port of the hydraulic fluid chamber to the isolation valve without pushing the hydraulic fluid through the second output port of the hydraulic fluid chamber to the accumulator valve; and
during the AEB event, the hydraulic fluid is to flow from the AEB pressure accumulator to a wheel brake through the pressure activation valve.

6. The brake system of claim 1, further including a check valve coupled between the pressure activation valve and a wheel brake.

7. The brake system of claim 1, wherein the isolation valve is connected to an anti-lock braking system valve.

8. A brake system comprising:
an automatic emergency braking (AEB) pressure accumulator;
an accumulator valve coupled to an input port of the AEB pressure accumulator; and
a pressure activation valve coupled to an output port of the AEB pressure accumulator, wherein:
during an AEB pre-charge phase, the accumulator valve is open and the pressure activation valve is closed, and
during an AEB event, the accumulator valve is closed and the pressure activation valve is open.

9. The brake system of claim 8, further including:
a hydraulic fluid chamber; and
an isolation valve between the hydraulic fluid chamber and wheel brakes, wherein, during the AEB pre-charge phase, the isolation valve is closed.

10. The brake system of claim 8, wherein, during the AEB pre-charge phase, the accumulator valve is to close after an increase in hydraulic pressure in the AEB pressure accumulator, the hydraulic pressure to be used during the AEB event.

11. The brake system of claim 8, wherein, during a non-AEB braking event, the accumulator valve is closed, and the pressure activation valve is closed.

12. The brake system of claim 11, further including:
a hydraulic fluid chamber;
an isolation valve coupled to the hydraulic fluid chamber; and
a piston, wherein:
during the non-AEB braking event, the piston is to push hydraulic fluid from the hydraulic fluid chamber to the isolation valve without pushing the hydraulic fluid to the accumulator valve; and
during the AEB event, the hydraulic fluid is to flow from the AEB pressure accumulator to a wheel brake through the pressure activation valve.

13. The brake system of claim 8, further including a check valve coupled between the pressure activation valve and a wheel brake.

14. A vehicle comprising:
a wheel brake;
an automatic emergency braking (AEB) pressure accumulator;
an isolation valve coupled to the wheel brake via a hydraulic fluid brake line;
an accumulator valve coupled to the AEB pressure accumulator; and
a pressure activation valve coupled to the AEB pressure accumulator, the pressure activation valve coupled to the wheel brake via the hydraulic fluid brake line.

15. The vehicle of claim 14, further including:
a hydraulic fluid chamber, the isolation valve located between the hydraulic fluid chamber and the wheel brake;
a piston in the hydraulic fluid chamber; and
a motor coupled to the piston, wherein, during an AEB pre-charge phase:
the isolation valve is closed, the accumulator valve is open, and the pressure activation valve is closed; and
the motor drives the piston to push hydraulic fluid from the hydraulic fluid chamber through the accumulator valve to the AEB pressure accumulator.

16. The vehicle of claim 15, wherein the accumulator valve is to close after an increase in hydraulic pressure in the AEB pressure accumulator based on the hydraulic fluid, the hydraulic pressure to be used during an AEB event.

17. The vehicle of claim 14, wherein:
during a non-AEB braking event, the isolation valve is open, the accumulator valve is closed, and the pressure activation valve is closed; and
during an AEB event, the isolation valve is open, the accumulator valve is closed, and the pressure activation valve is open.

18. The vehicle of claim 17, further including:
a hydraulic fluid chamber; and
a piston in the hydraulic fluid chamber, wherein:
during the non-AEB braking event, the piston is to push hydraulic fluid from the hydraulic fluid chamber to the isolation valve without pushing the hydraulic fluid to the accumulator valve; and
during the AEB event, the hydraulic fluid is to flow from the AEB pressure accumulator to the wheel brake through the pressure activation valve.

19. The vehicle of claim 14, further including a check valve coupled between the pressure activation valve and the wheel brake.

20. The vehicle of claim 14, wherein the isolation valve is connected to an anti-lock braking system valve.
